(19) United States
(12) Patent Application Publication
(10) Pub. No.: US 2009/0220141 A1
(43) Pub. Date: Sep. 3, 2009

(54) IMAGE PROCESSING APPARATUS, IMAGE PROCESSING METHOD, AND IMAGE PROCESSING PROGRAM

(75) Inventors: Takahiro AOKI, Kawasaki (JP); Soichi HAMA, Kawasaki (JP); Mitsuaki FUKUDA, Kawasaki (JP); Narutaka NAKAO, Kawasaki (JP); Hideki SATOGUCHI, Kawasaki (JP); Masahide YAGINUMA, Sendai (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/396,752

(22) Filed: Mar. 3, 2009

(30) Foreign Application Priority Data
Mar. 3, 2008 (JP) 2008-052585

(51) Int. Cl. G06K 9/00; G06K 9/40

(52) U.S. Cl. 382/134; 382/274

(57) ABSTRACT

A blood vessel imaging device obtains peak height information of a differential function F′(x) from an adjustment dial. The blood vessel imaging device, based on the peak height information and peak position information of the differential function F′(x), then defines the differential function F′(x). Subsequently, the blood vessel imaging device calculates an LUT function F(x) that indicates the shape of an LUT by integrating the defined differential function F′(x). The blood vessel imaging device generates an LUT based on the LUT function F(x). The blood vessel imaging device reads out a picked-up image stored in a picked-up image memory, converts a luminance value of the picked-up image being read using the LUT, and displays the image with the converted luminance value.

### BACKGROUND OF THE INVENTION

1. Field of the Invention

The present invention relates to an image processing apparatus that converts a luminance value of an image, by using a look-up table that indicates a corresponding relationship between a luminance value of an input image and a luminance value of an output image, an image processing method, and an image processing program.

2. Description of the Related Art

An image correction process that converts a luminance value of an image such as a photographed still image and a moving image has been widely performed in various fields. For example, if a part of an image taken by a digital still camera or a video camera is dark or difficult to see, it is possible to correct brightness and adjust contrast even at home, by scanning the image into a personal computer or the like.

The image correction is also carried out with respect to a medical image. For example, a medical image such as an image of subcutaneous veins captured using near infrared rays (see Japanese Patent Application Laid-open No. H8-510393), or an image of internal human body captured using X-rays is used to diagnose disease. However, because the images are of internal human body, it is not necessarily possible to obtain a clear and a user friendly image. Accordingly, the photographed image has been converted into a user friendly image.

A known method to correct such an image is a contrast adjusting method. Such methods that adjust the contrast in an image include a “contrast enhancement method”. More specifically, in the contrast enhancement method, the difference between a bright portion and a dark portion in an image is increased, by converting the luminance value and increasing brightness difference (see FIG. 14). In an example of FIG. 14, Y indicates a luminance value of an input image, Y′ indicates a converted luminance value, C indicates a parameter of contrast enhancement, and the luminance value Y takes a value of 256 levels of 0 to 255. The contrast of an image is adjusted by appropriately adjusting C.

In the contrast enhancement method, a conversion equation shown in FIG. 14 may be applied to all the pixels in an image. However, in a real process, it takes too long to calculate. Accordingly, a method of creating a conversion table called a look-up table (LUT) is known.

The LUT is a conversion table that indicates a corresponding relationship between a luminance value of an input image and a luminance value of an output image (see FIG. 15). A corresponding luminance value is read out from the table with each pixel of the input image, and set to the corresponding pixel of the output image. The image is corrected by converting the luminance value.

In the contrast enhancement method (see FIG. 14), all the luminance values in the image are equally enhanced, because the gradient of the whole LUT is changed. Accordingly, a so-called “white-out” condition may occur by exceeding the luminance value of 255, thereby degrading the quality of image. The output luminance values in an area encircled by a dotted line in FIG. 16 exceed the maximum luminance value of “255” and, as a result, will be converted into the maximum luminance value of 255. Accordingly, the information related to the luminance values is lost, making the image very difficult to see. Similarly, low luminance values are converted into the luminance value of 0.

Therefore, the contrast enhancement method is not usually used alone, but often used with, for example, a γ correction method that adjusts the brightness of image. The γ correction method is also widely used in image processing, and the luminance value Y of an image is converted, based on a conversion equation shown in FIG. 17.

In an image processing combined with the contrast enhancement method and the γ correction method, the two correction processes are appropriately adjusted. If the contrast adjustment and the γ correction are both carried out at the same time, as shown in FIGS. 17 and 18, the differential value of the differential function of the LUT is increased, simply with an increase of the luminance value. This means that the higher the luminance value, the higher the luminance resolution.

As an image correction method, a method of detecting information on spatial change (edge) in the luminance value of an image to be corrected, and using the detection result to correct the image is known (see Japanese Patent Application Laid-open No. H7-306938). More specifically, a histogram that indicates a relationship between the luminance value and the edge in the image is created, by searching the edge in the image.

The histogram, when a certain luminance value is in focus, shows to what extent an edge or a change in luminance value exists around the luminance value. For example, information such as in a certain image, there are many edges around a pixel with the luminance value of 100, but there is hardly any edge around a pixel with the luminance value of 200 can be obtained from the histogram.

By vertically inverting the histogram, a histogram in which the frequency is increased in the luminance value without an edge is generated. By integrating the obtained histogram, an LUT in which the gradient increases with the luminance value without an edge, and the gradient decreases with the luminance value with many edges is generated.

In the method that performs image processing by combining the contrast enhancement method and the γ correction method, the two correction processes need to be adjusted appropriately. Accordingly, the adjustment is very difficult.

In the technology that performs image processing by using the change in the luminance value, the conversion of the luminance value with respect to the input image is uniquely determined. Accordingly, the contrast cannot be adjusted at will, by a user or according to a purpose. As a result, a flexible image correction cannot be performed. Because the histogram needs to be built by searching the edge in the image, a long processing time is required.

### SUMMARY

It is an object of the present invention to at least partially solve the problems in the conventional technology.

According to an aspect of the present invention, an image processing apparatus that converts a luminance value of an image, by using a look-up table that indicates a corresponding relationship between a luminance value of an input image and a luminance value of an output image, includes a setting receiving unit that receives a setting related to a peak height and a peak position of a differential function of the look-up table; a table generating unit that, based on the peak height and the peak position received by the setting receiving unit, defines the differential function of the look-up table, calculates a function by integrating the differential function, and generates the look-up table in a shape indicated by the function; and a luminance value converting unit that, by using the look-up table generated by the table generating unit, converts the luminance value of the image.

According to another aspect of the present invention, an image processing method that converts a luminance value of an image, by using a look-up table that indicates a corresponding relationship between a luminance value of an input image and a luminance value of an output image, includes receiving a setting related to a peak height and a peak position of a differential function of the look-up table; defining, based on the received peak height and the received peak position, the differential function of the look-up table; calculating a function by integrating the defined differential function; generating the look-up table in a shape indicated by the function; and converting, by using the generated look-up table, the luminance value of the image.

According to still another aspect of the present invention, a computer-readable recording medium stores therein a computer program that implements the above method on a computer.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of a blood vessel imaging device according to a first embodiment of the present invention;

FIG. 2 is a schematic of an example of displaying a blood vessel image in which the contrast is enhanced;

FIG. 3 is a schematic for explaining an LUT;

FIG. 4 is a schematic for explaining a differential function F′(x) of an LUT function F(x);

FIG. 5 is a schematic for explaining the LUT function F(x);

FIG. 6 is a schematic for explaining a conversion process of a luminance value of an image;

FIG. 7 is a flowchart showing an operation of an LUT creation process performed by the blood vessel imaging device according to the first embodiment;

FIG. 8 is a flowchart showing an operation of an image display process performed by the blood vessel imaging device according to the first embodiment;

FIG. 9 is a block diagram of a medical image display device according to a second embodiment of the present invention;

FIG. 10 is a schematic for explaining a differential function F′(x) of an LUT function F(x);

FIG. 11 is a schematic for explaining the LUT function F(x);

FIG. 12 is a schematic for explaining a contrast enhancement process in a specified area;

FIG. 13 is a schematic of a computer that executes an image processing program;

FIG. 14 is a schematic for explaining a conventional technology;

FIG. 15 is another schematic for explaining the conventional technology;

FIG. 16 is still another schematic for explaining the conventional technology;

FIG. 17 is still another schematic for explaining the conventional technology; and

FIG. 18 is still another schematic for explaining the conventional technology.

### DETAILED DESCRIPTION OF THE PREFERRED EMBODIMENTS

Exemplary embodiments of an image processing apparatus, an image processing method, and an image processing program according to the present invention are described below in greater detail with reference to the accompanying drawings.

In the following embodiment, a configuration and a processing flow of a blood vessel imaging device according to a first embodiment of the present invention are sequentially described, and advantages of the first embodiment are also described. In the following, the embodiment is applied to a blood vessel imaging device that takes and displays an image of bloods vessel as a medical image. Such a blood vessel imaging device is used for assisting medical practices such as injection, by taking and displaying an image of subcutaneous veins using near infrared rays.

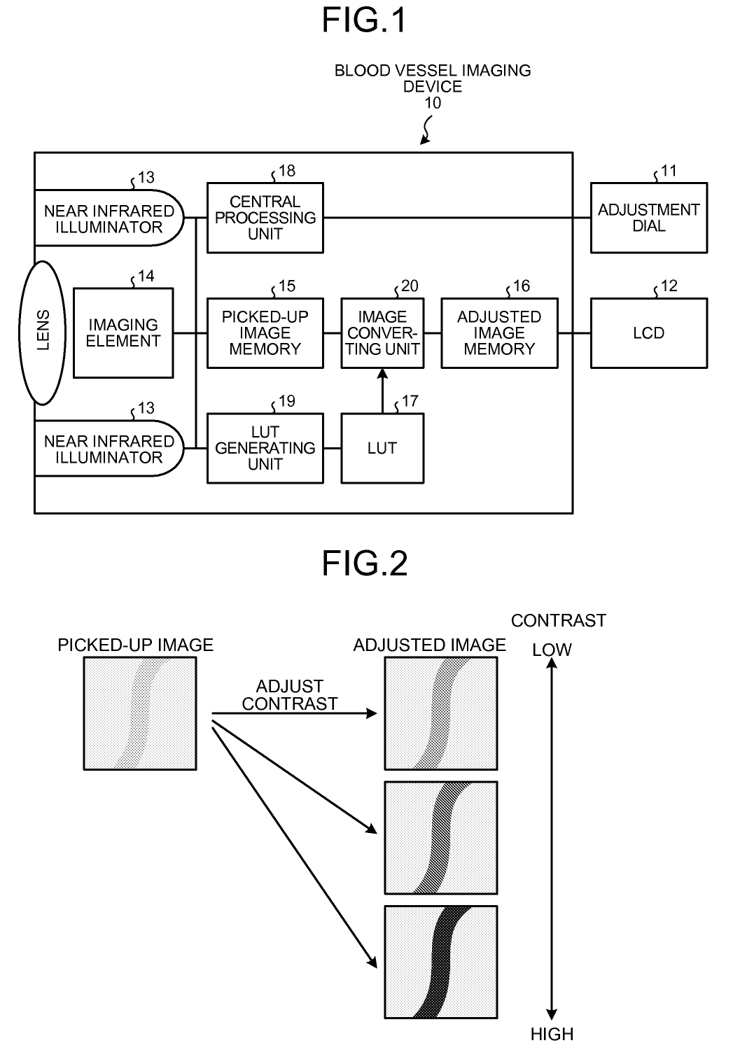

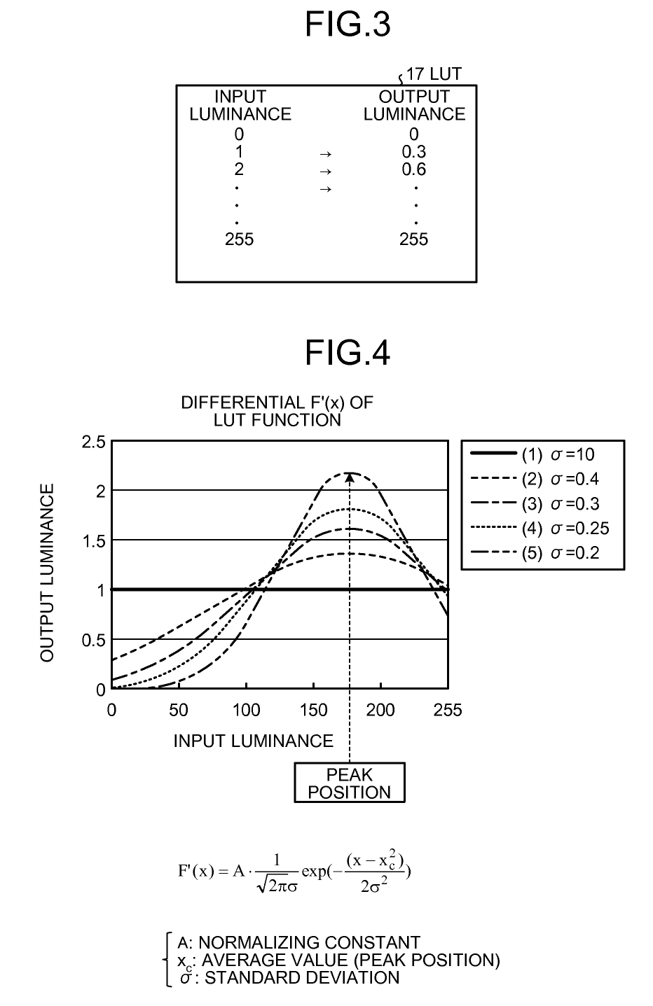

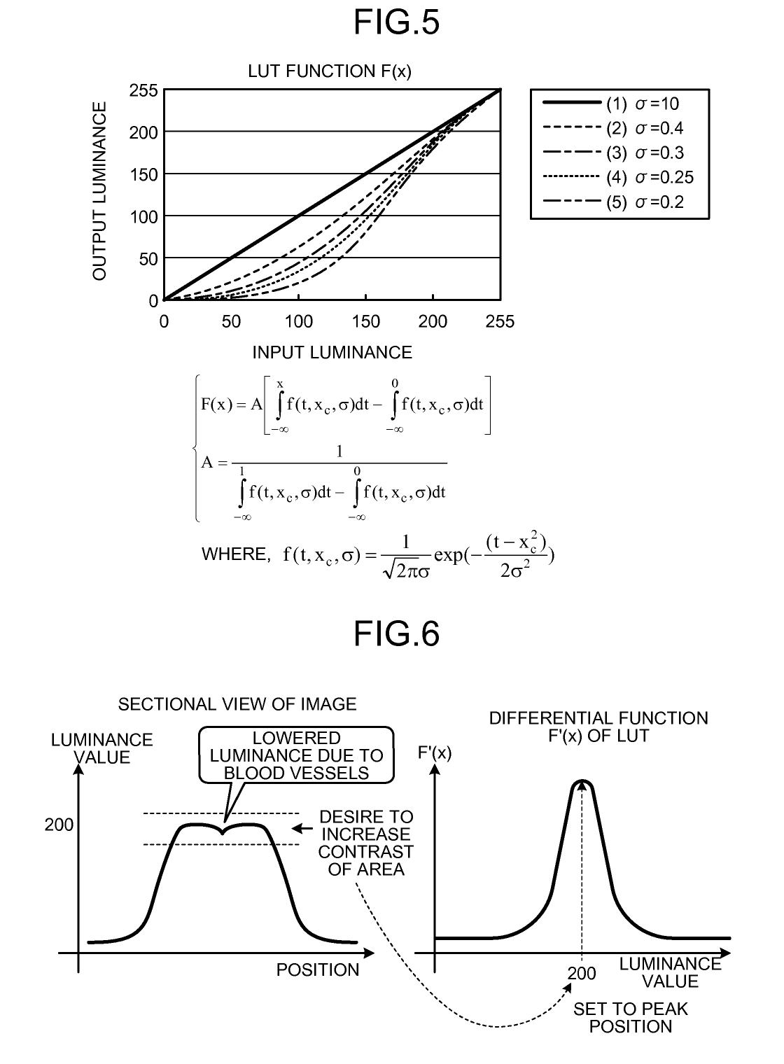

With reference to FIGS. 1 to 6, a configuration of a blood vessel imaging device 10 will be explained. FIG. 1 is a block diagram of the blood vessel imaging device 10 according to the first embodiment of the present invention. FIG. 2 is a schematic of an example of displaying a blood vessel image in which the contrast is enhanced. FIG. 3 is a schematic for explaining an LUT. FIG. 4 is a schematic for explaining a differential function F′(x) of an LUT function F(x). FIG. 5 is a schematic for explaining the LUT function F(x). FIG. 6 is a schematic for explaining a conversion process of a luminance value of an image.

As shown in FIG. 1, the blood vessel imaging device 10 includes an adjustment dial 11, an LCD 12, a near infrared illuminator 13, an imaging element 14, a picked-up image memory 15, an adjusted image memory 16, an LUT 17, a central processing unit 18, an LUT generating unit 19, and an image converting unit 20. The processing performed by each of the units will now be explained.

The adjustment dial 11 receives a peak height and a peak position of a differential function F′(x) of an LUT function F(x) that indicates the shape of an LUT, as a set input value. More specifically, the adjustment dial 11 receives an input value for adjusting the intensity of contrast set by a user. With the adjustment dial 11, it is possible that only the peak height of the differential function F′(x) may be adjusted, and the peak position (in other words, position in the x direction) may be set in advance. In the following example, only the peak height is adjusted.

To pick up an image of blood vessels, a subject to be photographed is mainly an arm, and the photographing will presumably take place in a lighting environment where the light of the lighting environment itself is emitted. Accordingly, the lighting is constant as long as there is no strong outside light such as sunlight. Therefore, a luminance value of the subject is more or less determined in advance, and for example, it is possible to set the peak position at the luminance value of about “200”, in advance. The luminance value of “200” corresponds to x=200/255=0.78, if “x” is a normalized luminance value.

If an LUT is generated so as the peak of the differential function F′(x) comes to the position of x=0.78, it is possible to improve luminance resolution around the luminance value of “200”, which is the corresponding luminance value. As a result, it is possible to improve the luminance resolution of the skin area and the blood vessel area, thereby improving the visibility of blood vessels.

The LCD 12 reads and displays an adjusted image in which the luminance value is converted by the image converting unit 20 and the contrast is enhanced, from the adjusted image memory 16. For example, the LCD 12, as shown in FIG. 2, displays a blood vessel image in which the contrast is enhanced. As shown in FIG. 2, the LCD 12 displays an image, in which the intensity (in other words, peak height of differential function F′(x)) of contrast is appropriately adjusted, based on the input value of the adjustment dial 11.

The near infrared illuminator 13 emits a human body, which is a subject to be photographed, using near infrared rays. The near infrared rays emitted from the near infrared illuminator 13 penetrate into human body, while hemoglobin highly contained in blood absorbs the near infrared rays. Accordingly, in the image of human body to which near infrared rays are emitted, only the vein looks dark. Although the blood vessel looks dark in the image taken using near infrared rays, because the blood vessels are in the human body, if the contrast is not enhanced, the blood vessels are not displayed very clearly. In other words, a difference in luminance values between the portion of surrounding skin and the portion of blood vessels is small.

The imaging element 14, on receiving an image pickup request from a user, picks up a subject emitted by the near infrared illuminator 13 through a lens, and stores in the picked-up image memory 15. The picked-up image memory 15 stores therein an image picked up by the imaging element 14. The adjusted image memory 16 stores therein an adjusted image in which the luminance value is converted by the image converting unit 20 and the contrast is enhanced. The picked-up image stored in the picked-up image memory 15 is an image picked up by the imaging element 14 without any change, and a difference in the luminance values between the blood vessel area and the other skin area is not so significant.

The LUT 17, as shown in FIG. 3, is a conversion table of a corresponding relationship between the luminance value of an input image and the luminance value of an output image, and generated by the LUT generating unit 19, which will be described later. The LUT 17 subtracts a corresponding luminance value from the table with each pixel of the input image, and sets to the corresponding pixel of the output image. An image is corrected by converting the luminance value.

The central processing unit 18 obtains an input value of the differential function F′(x) from the adjustment dial 11, and notifies to the LUT generating unit 19. More specifically, the central processing unit 18, when the power is turned on, obtains an input value that indicates the peak height of the differential function F′(x) from the adjustment dial 11. The central processing unit 18, based on the input value, then sets standard deviations “σ” shown in FIG. 4, which will be described later, and notifies the LUT generating unit 19.

A description will now be given by using a specific example. The central processing unit 18, if a user maximally lowered the contrast by adjusting the adjustment dial 11, is set to “σ=10.0”, and if a user maximally increased the contrast, is set to “σ=0.2”. A conversion equation may be used, or a conversion table may be created in advance, to determine “σ” based on the input value from the adjustment dial 11.

The LUT generating unit 19, based on the peak position information and the peak height information, defines the differential function F′(x), and calculates an LUT function F(x) that indicates the shape of the LUT by integrating the differential function F′(x). More specifically, the LUT generating unit 19, based on the standard deviation “σ” received from the central processing unit 18 and an average value “Xc” of a normal distribution set in advance, defines the differential function F′(x). Then, the LUT generating unit 19 calculates an LUT function F(x) that indicates the shape of the LUT, by integrating the differential function F′(x). The LUT generating unit 19 generates an LUT, based on the LUT function F(x).

With reference to FIG. 4, the differential function F′(x) of the LUT function F(x) will now be explained. In FIG. 4, the differential function F′(x) is expressed using normal distribution. As shown in FIG. 4, the differential function F′(x) of the LUT function defined in the LUT generating unit 19 shows the resolution of the corresponding luminance. In other words, as shown in FIG. 4, the differential indicates the gradient of the corresponding function. Accordingly, a small difference in the input luminance is enhanced and output, at a portion with a large differential. On the other hand, the change in the input luminance is lowered and output, with the luminance value that has a small differential.

In an example of FIG. 4, the standard deviation “σ” corresponds to the adjustment parameter of contrast enhancement, when the average value (Xc) of the normal distribution is at the peak position, thereby showing various differential functions with respect to “σ”. “A” is a constant applied to the entire function, and uniquely determined by a normalizing condition, which will be shown below.

As shown in FIG. 5, the LUT function indicates a relational expression between the input luminance value and the output luminance value, and is shown as F(x). x is a normalized value of a luminance value Y(0-255). In other words, if the luminance value at a certain focus point is Y, it is x=(Y/255). x takes a value in a range between 0.0 to 1.0. By being normalized, it is possible to apply the similar formula, even if the range of the luminance value is outside 0-255.

By setting “F(0.0)=0.0” and “F(1.0)=1.0” as a normalizing condition, the LUT function F(x) is uniquely determined as shown in FIG. 5, by keeping the output luminance value in the range between “0.0” to “1.0”. However, the calculated value may be kept in a table in advance, instead of integrating.

In other words, with respect to the LUT function F(x) that indicates the shape of the LUT, an LUT is generated by defining the differential function F′(x) of F(x) at first, and integrating thereof. Accordingly, it is possible to adjust the luminance resolution around a predetermined luminance value.

For example, when the blood vessels are picked up and displayed, the luminance values of the skin and the vessel portion are approximately the same. Accordingly, as shown in FIG. 6, by generating the LUT 17 so as a corresponding luminance value (such as luminance value of “200”) comes to the peak position of the differential, a lowered luminance value due to the presence of blood vessels can be selectively enhanced. The left side in FIG. 6 indicates a state of the section of the luminance value, when an image of human arm is picked up, and the horizontal axis indicates a position and the vertical axis indicates the corresponding luminance value. Around the center of the image is the center portion of the arm, and the luminance lowered due to the blood vessel located there is displayed by increasing the contrast.

If the degree of enhancement process is adjusted by the adjustment dial 11, the peak position of the differential function F′(x) is fixed, and only the peak height changes. This means that the sensitivity of the output luminance value at the luminance value is being adjusted.

The image converting unit 20, by using the LUT 17, converts the luminance value of a picked-up image. More specifically, the image converting unit 20 reads out the picked-up image stored in the picked-up image memory 15, converts the luminance value of the picked-up image being read by using the LUT 17, and stores in the adjusted image memory 16.

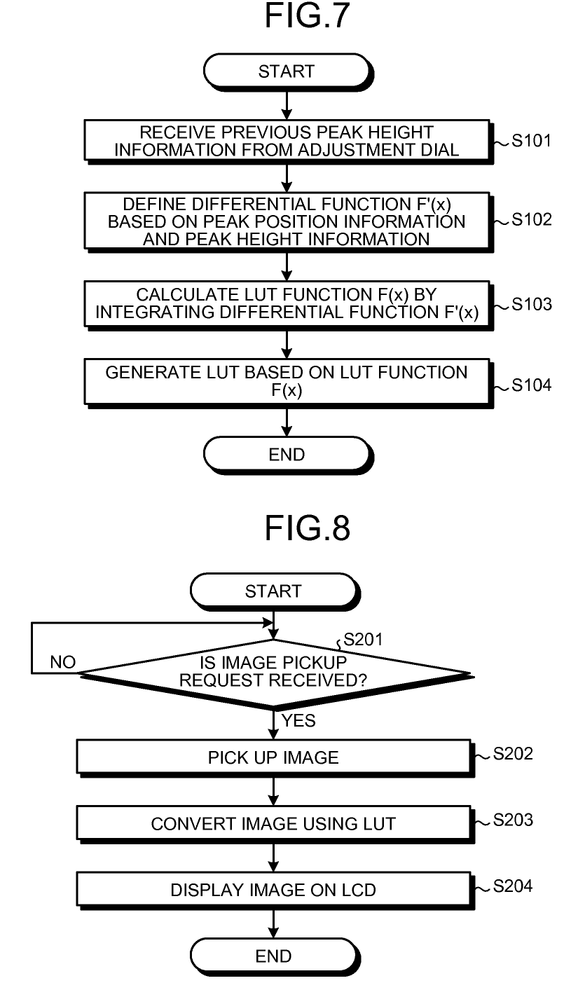

With reference to FIGS. 7 and 8, a process performed by the blood vessel imaging device 10 according to the first embodiment will be explained. FIG. 7 is a flowchart showing an operation of an LUT creation process performed by the blood vessel imaging device according to the first embodiment. FIG. 8 is a flowchart showing an operation of an image display process performed by the blood vessel imaging device according to the first embodiment.

As shown in FIG. 7, the blood vessel imaging device 10, on receiving the peak height information of the differential function F′(x) from the adjustment dial 11 (Step S101), defines the differential function F′(x), based on the peak height information and the peak position information of the differential function F′(x) (Step S102).

The blood vessel imaging device 10 then calculates an LUT function F(x) that indicates the shape of the LUT, by integrating the defined differential function F′(x) (Step S103). Then, the blood vessel imaging device 10 creates an LUT, based on the LUT function F(x) (Step S104).

With reference to FIG. 8, an operation of an image display operation performed by the blood vessel imaging device 10 according to the first embodiment will be explained. As shown in FIG. 8, the blood vessel imaging device 10, on receiving an image pickup request from a user (Step S201), picks up an image of a subject emitted by the near infrared illuminator 13 through a lens, and stores in the picked-up image memory 15 (Step S202).

The blood vessel imaging device 10 then reads out the picked-up image stored in the picked-up image memory 15, converts the luminance value of the picked-up image being read using the LUT 17, and stores in the adjusted image memory 16 (Step S203). The blood vessel imaging device 10 then reads out the adjusted image in which the luminance value is converted and the contrast is enhanced, from the adjusted image memory 16, and displays the image (Step S204).

As described above, the blood vessel imaging device 10 can flexibly control the distribution, by using a method that focuses on the differential function of the LUT function, and sets the differential function into a predetermined shape. In other words, the luminance resolution (the change in output luminance value with respect to the change in input luminance value) is increased in the luminance value that includes the peak of the differential function. On the contrary, the luminance resolution is lowered in a range other than the peak. By defining the peak position (x direction) and the peak height (y direction) using a self-set function, it is possible to perform a flexible image correction process at ease.

In the blood vessel imaging device 10, the peak height is adjusted while maintaining a certain peak position. Accordingly, it is possible to adjust contrast, while maintaining the luminance value with the highest luminance resolution.

In the blood vessel imaging device 10, on determining the LUT function, a normalizing condition is set after the differential function is integrated. Under the condition, it is possible to suppress the number of white-out pixels, while increasing luminance resolution of the luminance value in focus.

In the first embodiment, when the image that picked up the blood vessels is processed by using the LUT is explained. However, the present invention is not limited to this, and an image formed by various images (such as medical image of subject emitted by visible light and ultraviolet rays) or by a plurality of planes can be processed using a plurality of LUTs.

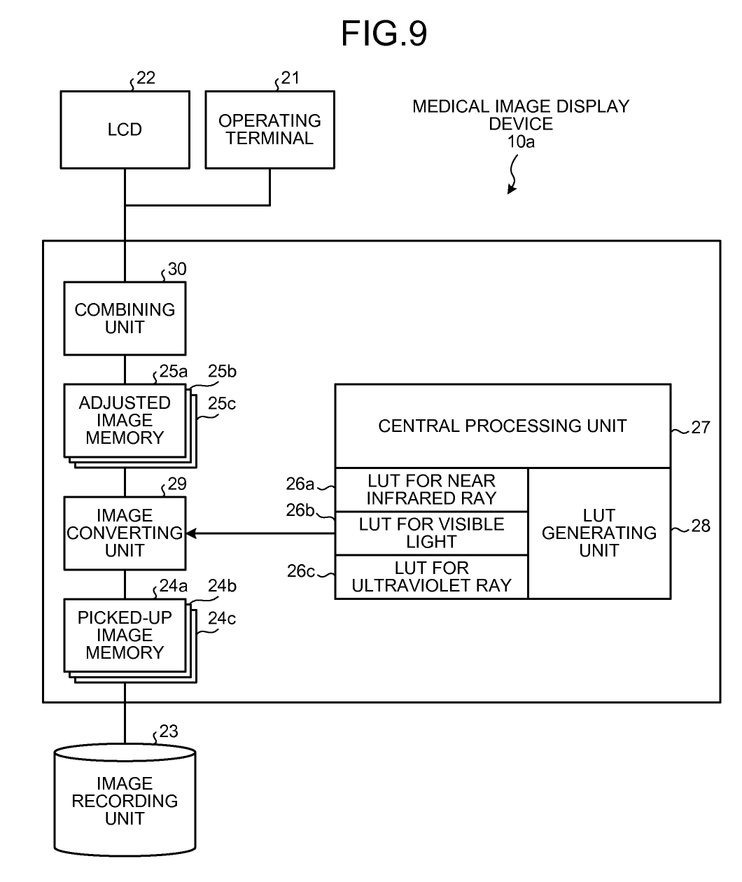

In the following second embodiment, a configuration of a medical image display device 10a according to a second embodiment is explained with reference to FIG. 9, as when the embodiment is applied to a medical image display device that displays an image in which a plurality of images (planes) are combined. FIG. 9 is a block diagram of a medical image display device according to the second embodiment. Descriptions that overlap with the first embodiment will be omitted.

As shown in FIG. 9, the medical image display device 10a is different from the blood vessel imaging device 10 shown in FIG. 1, by including an operating terminal 21, an image recording unit 23, a plurality of picked-up image memories 24a to 24c, a plurality of adjusted image memories 25a to 25c, a plurality of LUTs 26a to 26c, and a combining unit 30. In the following, an example of including three LUTs that are suitable for processing each medical image picked up by emitting near infrared rays, visible light, or ultraviolet rays will be explained.

The operating terminal 21 receives a request to pick up a medical image of a subject desired by a user, and among the medical images of the subject, receives which of the medical image picked up by emitting near-infrared rays, visible light, or ultraviolet rays is to be combined.

The operating terminal 21 inputs the peak height and the peak position of the differential function F′(x) of each image, picked by emitting near-infrared rays, visible light, or ultraviolet rays, as an input value. For example, the operating terminal 21 includes three dials that adjust the respective contrast intensity of the near infrared rays, the visible light, and the ultraviolet rays. Each dial that contains input values of “high” having a high contrast, “low” having a low contrast, and “off” that is not to be combined, is adjusted by a user.

The image recording unit 23 stores therein each medical image picked up by emitting near infrared rays, visible light, and ultraviolet rays. The image recording unit 23 stores therein the same subject, respectively, to overlap and combine each of the medical images.

The picked-up image memories 24a to 24c, among the medical images stored in the image recording unit 23, stores therein a medical image of the subject specified by the operating terminal 21 being the medical image to be combined. The picked-up image memory 24a stores therein a medical image picked by emitting near infrared rays, the picked-up image memory 24b stores therein a medical image picked up by emitting visible light, and the picked-up image memory 24c stores therein a medical image picked up by emitting ultraviolet rays.

The adjusted image memory 25a stores therein the medical image picked up by emitting near infrared rays in which the luminance value is converted by the LUT 26a for near infrared rays. The adjusted image memory 25b stores therein the medical image picked up by emitting visible light in which the luminance value is converted by an LUT 26b for visible light. The adjusted image memory 25c stores therein the medical image picked up by emitting ultraviolet rays in which the luminance value is converted by the LUT 26c for ultraviolet rays.

The LUT 26a for near infrared rays stores therein a conversion table that indicates a corresponding relationship between the luminance value of the input image and the luminance value of the output image, to convert the luminance value with respect to the near infrared ray image stored in the adjusted image memory 25a. The LUT 26b for visible light stores therein a conversion table for converting the luminance value with respect to the visible light image stored in the adjusted image memory 25b. The LUT 26c for ultraviolet rays stores therein a conversion table for converting the luminance value with respect to the ultraviolet ray image stored in the adjusted image memory 25c.

The central processing unit 27 obtains each input value (in other words, each piece of peak position information and each piece of peak height information) for near infrared rays, visible light, and ultraviolet rays from the operating terminal 21, and notifies to an LUT generating unit 28.

The LUT generating unit 28 receives each input value from the central processing unit 27, generates each of the LUTs for near infrared rays, visible light, and ultraviolet rays based on the input value, and stores them respectively in the LUT 26a for near infrared rays, the LUT 26b for visible light, and the LUT 26c for ultraviolet rays. For an image with which a notification that the image is not to be combined is input from the operating terminal 21, no input value is notified from the central processing unit 18, and no LUT is generated.

An image converting unit 29 converts the luminance value of each medical image stored in the picked-up image memories 24a to 24c, by using each of the LUTs 26a to 26c. More specifically, the image converting unit 29 reads out the near infrared image stored in the picked-up image memory 24a, converts the luminance value of the picked-up image being read, by using the LUT 26a for near infrared rays, and stores in the adjusted image memory 25a. The image converting unit 29 also reads out the visible light image stored in the picked-up image memory 24b, converts the luminance value of the picked-up image being read, by using the LUT 26b for visible light, and stores in the adjusted image memory 25b. The image converting unit 29 also reads out the ultraviolet ray image stored in the picked-up image memory 24c, converts the luminance value of the picked-up image being read, by using the LUT 26c for ultraviolet rays, and stores in the adjusted image memory 25c.

The combining unit 30 reads out each medical image in which the luminance value is converted, from the adjusted image memories 25a to 25c, overlaps and combines the medical images, and displays by transmitting to an LCD 22.

In this manner, a plurality of images is combined by converting the luminance value using the respective LUTs. Accordingly, it is possible to obtain an appropriate image according to a purpose. For example, to pick up images of oxygenated hemoglobin and reduced hemoglobin of which the most absorbing wavelengths are different, the different LUTs are used to correct the image of the oxygenated hemoglobin and the image of the reduced hemoglobin. Subsequently, it is possible to obtain an appropriate image according to a medical purpose, such as an image in which only the distribution of oxygenated hemoglobin is enhanced.

While the embodiments of the present invention have been described, it is to be understood that various other modifications may be made to the present invention. The other embodiments included in the present invention will now be described as a third embodiment.

In the blood vessel imaging device 10 according to the first embodiment, the peak position of the differential function F′(x) is set in advance. However, the present invention is not limited to this, and the peak position of the differential function F′(x) may be set automatically. For example, an average luminance of a predetermined area around the center of an image is calculated, and the luminance value is set as the peak position. The average luminance is calculated here, to reduce the impact caused by noise.

In this manner, the average luminance value of an area that interests a user is calculated in advance (for example, around the center of image), and the calculated luminance value is set as the peak position. Accordingly, it is possible to set the peak position automatically.

In the blood vessel imaging device 10 according to the first embodiment, one peak is set. However, the present invention is not limited to this, and a plurality of peaks may be set. For example, a medical X-ray image and the like may be broadly separated into a bright portion such as bones and a dark portion such as the other tissues. Accordingly, it is possible to set the peaks with respect to the portions that have different luminance values within the image.

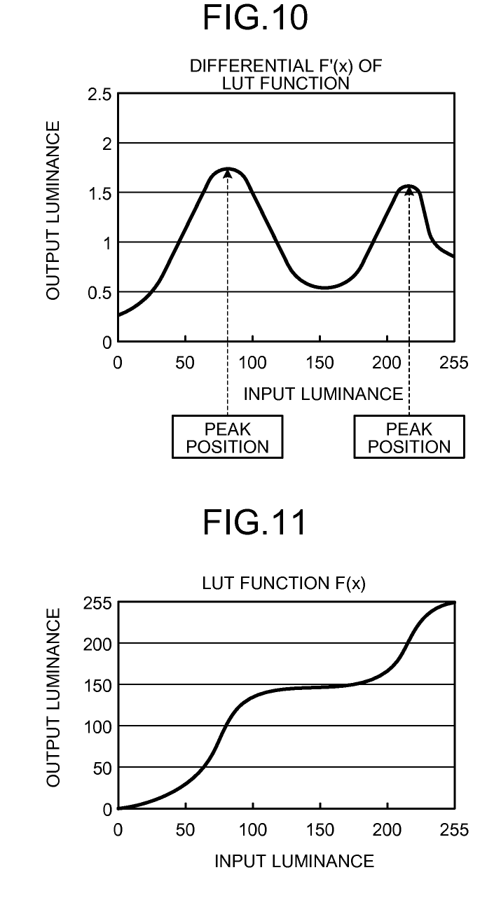

More specifically, the blood vessel imaging device, as shown in FIG. 10, defines a differential function F′(x) with two peaks. The blood vessel imaging device, as shown in FIG. 11, calculates an LUT function F(x) that indicates the shape of an LUT, by integrating the defined differential function F′(x). Then, the blood vessel imaging device creates an LUT based on the LUT function F(x).

In this manner, the peaks are respectively set for the portions that have different luminance values within the image (such as bright portion and dark portion). Accordingly, it is possible to enhance the respective areas.

In the blood vessel imaging device 10 according to the first embodiment, the peak position is fixed. However, the present invention is not limited to this, and the peak position may be set at any position specified by a user.

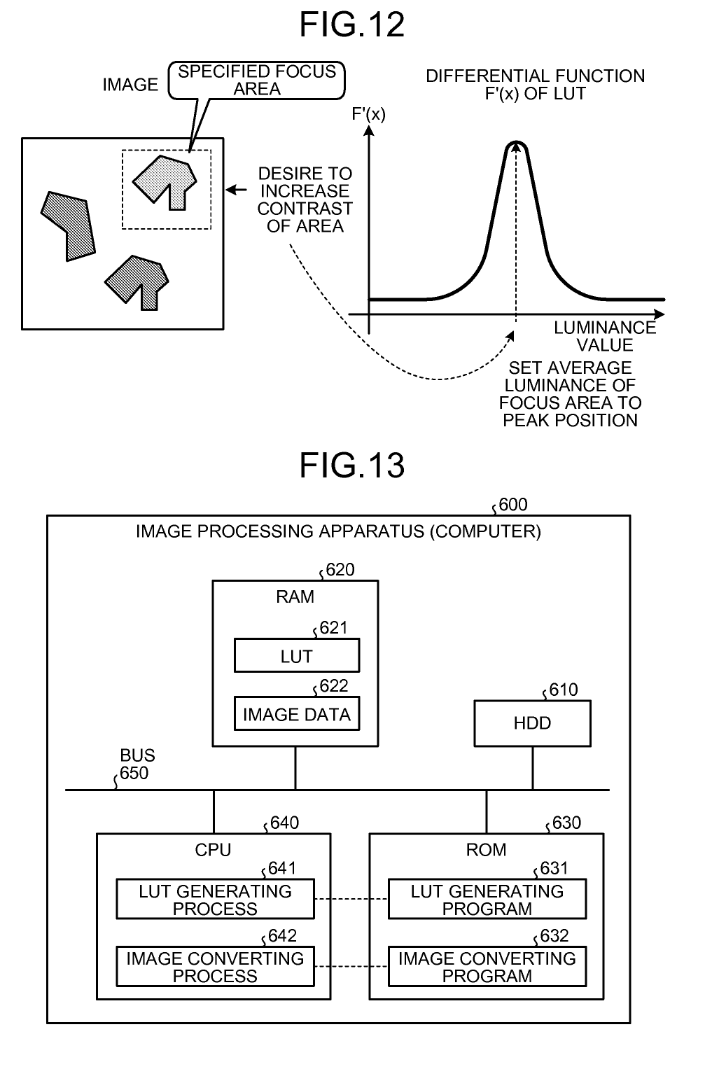

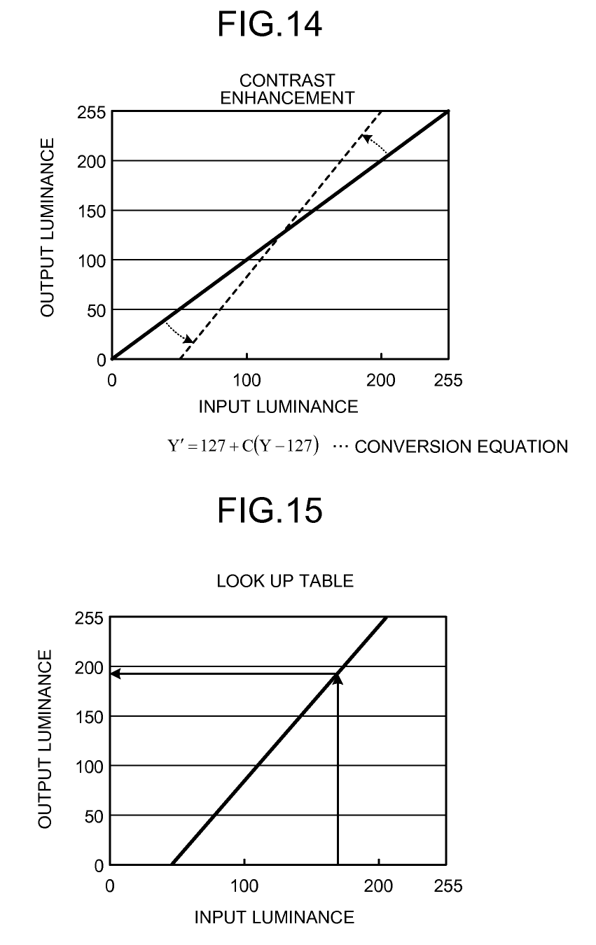

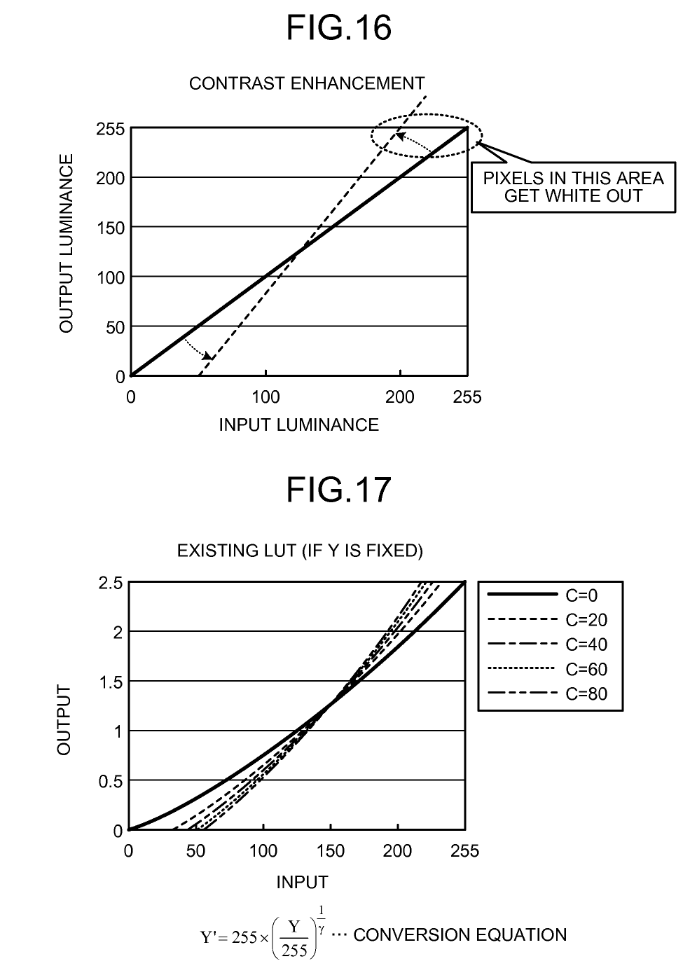

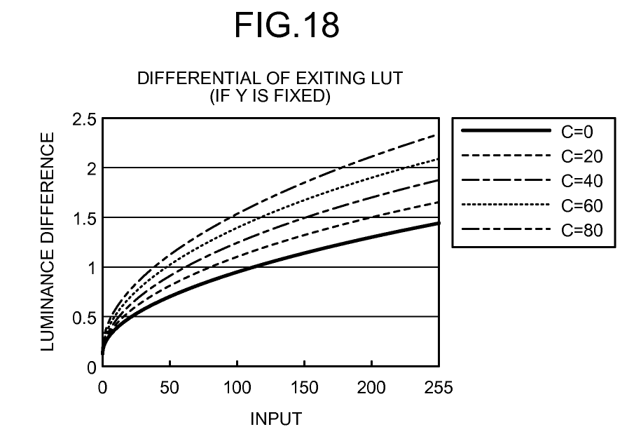

For example, the blood vessel imaging device, as shown in FIG. 12, displays an X-ray image on a display device. A doctor specifies any position or an area within the image, thereby detecting the luminance value at the specified area. The detected luminance value is set as the peak position of the differential function F′(x). The area that a user desires to focus in the image is specified by using a touch pen, a mouse, and the like (in FIG. 12, an area enclosed by a dotted line).

In this manner, the luminance of any area specified by a user is set as the peak position. Accordingly, it is possible to display an image in which the contrast of the specified area is enhanced.

In the first embodiment, a monochrome image is applied thereto. However, the present invention is not limited to this, and an image formed of a plurality of planes such as a color image in which images of a plurality of wavelengths (such as wavelengths of red (R), green (G), and blue (B)) are overlapped, and a false-color image in which images taken by the wavelength different from that of R, G, and B are overlapped may be applied thereto.

As a specific application example, for example, when a plant absorbs light for photosynthesizing, the light with a short wavelength is absorbed more, while light of a near infrared ray area with a long wavelength is not absorbed much but reflected. As a result, on viewing a satellite image taken using near infrared rays, for example, an area with more plants looks bright. By overlapping the image taken using near infrared rays with an image of “red”, which is the most noticeable color to the human eye, it is possible to view the distribution of plant.

For a medical purpose, it is also possible to obtain information related to living body, by taking an image using a certain wavelength. For example, in an image taken by the wavelength most absorbed by oxygenated hemoglobin, the less the luminance value, the more oxygenated hemoglobin exists. Therefore, it is possible to visualize the distribution of oxygenated hemoglobin and reduced hemoglobin, for example, by converting the luminance values thereof using the respective LUTs. This is enabled by inverting the converted images (subtract from 255), and overlapping and combining the images while allocating red and blue to each of the images.

The respective constituents of the illustrated apparatuses are functionally conceptual, and need not necessarily be physically configured as illustrated. In other words, the specific mode of dispersion and integration of each apparatus is not limited to the ones shown in the drawings, and all or a part thereof can be functionally or physically dispersed or integrated in an optional unit, depending on various kinds of load and the status of use. For example, the central processing unit 18 and the LUT generating unit 19 may be integrated in the first embodiment. All or an optional part of the respective processing functions carried out in each apparatus are realized by a central processing unit (CPU) and a computer program analyzed and executed by the CPU, or may be realized as hardware by the wired logic.

With each process described in the present embodiments, all or a part of the processes as being described as automatically performed may be manually performed, or all or a part of the processes described as being manually performed may be automatically performed with a known method. The information including the process procedure, the control procedure, specific names, and various kinds of data and parameter shown in the specification or in the drawings can be optionally changed unless otherwise specified.

Various kinds of process described in the embodiments can be performed by executing a computer program prepared in advance using a computer. An example of a computer that executes a computer program having the similar function to that of the embodiments will now be explained, with reference to FIG. 13. FIG. 13 is a schematic of a computer that executes an image processing program.

As shown in FIG. 13, a computer 600 as an image processing apparatus includes a hard disk drive (HDD) 610, a random access memory (RAM) 620, a read-only memory (ROM) 630, and a CPU 640 connected by a bus 650.

The ROM 630 stores therein an image processing program that performs the similar function to that of the embodiments. In other words, as shown in FIG. 13, the ROM 630 stores therein an LUT generating program 631 and an image converting program 632 in advance. With the programs 631 and 632, it is possible to appropriately integrated or dispersed, similar to the respective constituents of the image processing apparatus shown in FIG. 1.

The CPU 640 reads out the programs 631 and 632 from the ROM 630 and executes. Accordingly, as shown in FIG. 13, each of the programs 631 and 632 functions as an LUT generating process 641 and an image converting process 642. Each of the processes 641 and 642 respectively corresponds to the LUT generating unit 19 and the image converting unit 20.

The RAM 620, as shown in FIG. 13, stores therein an LUT 621 and image data 622. Based on the stored LUT 621 and the image data 622, the RAM 620 executes the image converting process shown in FIG. 1.

In the embodiments, the edge calculation and the like are not required, and the peak position and the peak height of the differential function can be set flexibly. Accordingly, it is possible to advantageously perform a flexible image correction at high speed, with a simple adjustment.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image processing apparatus that converts a luminance value of an image, by using a look-up table that indicates a corresponding relationship between a luminance value of an input image and a luminance value of an output image, the image processing apparatus comprising:
a setting receiving unit that receives a setting related to a peak height and a peak position of a differential function of the look-up table;
a table generating unit that, based on the peak height and the peak position received by the setting receiving unit, defines the differential function of the look-up table, calculates a function by integrating the differential function, and generates the look-up table in a shape indicated by the function; and
a luminance value converting unit that, by using the look-up table generated by the table generating unit, converts the luminance value of the image.

2. The image processing apparatus according to claim 1, wherein the table generating unit normalizes the shape indicated by the function obtained by integrating the differential function.

3. The image processing apparatus according to claim 1, wherein
the setting receiving unit receives a setting related to a plurality of peak heights and a plurality of peak positions, and
the table generating unit, based on the peak heights and the peak positions received by the setting receiving unit, defines the differential function of the look-up table, calculates a function by integrating the differential function, and generates the look-up table in the shape indicated by the function.

4. The image processing apparatus according to claim 1, wherein
the setting receiving unit, with respect to an image formed by a plurality of planes, receives a setting related to a peak height and a peak position with respect to each of the planes,
the table generating unit generates a plurality of look-up tables each for the peak heights and the peak positions with respect to each of the planes received by the setting receiving unit, and
the luminance value converting unit, by using the look-up tables generated by the table generating unit, converts each luminance value of the plane that corresponds to each of the look-up tables, and
further comprising an image combining unit that overlaps images by combining each of the planes converted by the luminance value converting unit.

5. The image processing apparatus according to claim 1, further comprising:
an image area receiving unit that receives a specified area in the image; and
a luminance value detecting unit that detects the luminance value of the specified area received by the image area receiving unit; wherein
the table generating unit generates the look-up table having the luminance value calculated by the luminance value detecting unit as the peak position.

6. An image processing method that converts a luminance value of an image, by using a look-up table that indicates a corresponding relationship between a luminance value of an input image and a luminance value of an output image, the image processing method comprising:
receiving a setting related to a peak height and a peak position of a differential function of the look-up table;
defining, based on the received peak height and the received peak position, the differential function of the look-up table;
calculating a function by integrating the defined differential function;
generating the look-up table in a shape indicated by the function; and
converting, by using the generated look-up table, the luminance value of the image.

7. The image processing method according to claim 6, further comprising normalizing the shape indicated by the function obtained by integrating the differential function.

8. The image processing method according to claim 6, further comprising:
receiving a setting related to a plurality of peak heights and a plurality of peak positions;
defining, based on the received peak heights and the received peak positions, the differential function of the look-up table;
calculating a function by integrating the differential function; and
generating the look-up table in the shape indicated by the function.

9. The image processing method according to claim 6, further comprising:
receiving, with respect to an image formed by a plurality of planes, a setting related to a peak height and a peak position with respect to each of the planes;
generating a plurality of look-up tables each for the received peak heights and the received peak positions with respect to each of the planes;
converting, by using the generated look-up tables, each luminance value of the plane that corresponds to each of the look-up tables; and
overlapping images by combining each of the converted planes.

10. The image processing method according to claim 6, further comprising:
receiving a specified area in the image;
detecting the luminance value of the received specified area; and
generating the look-up table having the luminance value calculated as the peak position.

11. A computer-readable recording medium that stores therein a computer program that converts a luminance value of an image, by using a look-up table that indicates a corresponding relationship between a luminance value of an input image and a luminance value of an output image, the computer program causing a computer to execute:
receiving a setting related to a peak height and a peak position of a differential function of the look-up table;
defining, based on the received peak height and the received peak position, the differential function of the look-up table;
calculating a function by integrating the defined differential function;
generating the look-up table in a shape indicated by the function; and
converting, by using the generated look-up table, the luminance value of the image.

12. The computer-readable recording medium according to claim 11, wherein the computer program further causes the computer to execute normalizing the shape indicated by the function obtained by integrating the differential function.

13. The computer-readable recording medium according to claim 11, wherein the computer program further causes the computer to execute:
receiving a setting related to a plurality of peak heights and a plurality of peak positions;
defining, based on the received peak heights and the received peak positions, the differential function of the look-up table;
calculating a function by integrating the differential function; and
generating the look-up table in the shape indicated by the function.

14. The computer-readable recording medium according to claim 11, wherein the computer program further causes the computer to execute:
receiving, with respect to an image formed by a plurality of planes, a setting related to a peak height and a peak position with respect to each of the planes;
generating a plurality of look-up tables each for the received peak heights and the received peak positions with respect to each of the planes;
converting, by using the generated look-up tables; each luminance value of the plane that corresponds to each of the look-up tables; and
overlapping images by combining each of the converted planes.

15. The computer-readable recording medium according to claim 11, wherein the computer program further causes the computer to execute:
receiving a specified area in the image;
detecting the luminance value of the received specified area; and
generating the look-up table having the luminance value calculated as the peak position.
